(19) United States
(12) Patent Application Publication
(10) Pub. No.: US 2005/0140988 A1
(43) Pub. Date: Jun. 30, 2005

(54) Optical critical dimension measurement equipment

(76) Inventors: Dong-gun Lee, Busan Metropolitan City (KR); Seong-woon Choi, Suwon-si (KR); Seong-yong Moon, Suwon-si (KR); Byung-gook Kim, Seoul (KR); Min-ah Kim, Seoul (KR)

Correspondence Address: VOLENTINE FRANCOS, P.L.L.C., Suite 150, 12200 Sunrise Valley Drive, Reston, VA, 20191, US

(21) Appl. No.: 10/919,367

(22) Filed: Aug. 17, 2004

(30) Foreign Application Priority Data
Dec. 29, 2003 (KR) 2003-99051

(51) Int. Cl. G01B 11/14

(52) U.S. Cl. 356/625

(57) ABSTRACT

An OCD measurement equipment, including a tunable laser system, and a method of measuring the CD of patterns formed on a substrate. A light source optical system emits light which wavelength changes over time. A projector optical system projects the light emitted from the light source optical system on the substrate. A substrate support unit supports the substrate. An image relay optical system relays light reflected by the substrate. An image detection optical system detects the light relayed by the image relay optical system using a detector which detects the spatial distribution of the light.

### BACKGROUND OF THE INVENTION

1. Field of the Invention

Embodiments of the present invention relate to measurement equipment for measuring the critical dimension (CD) of patterns and a method of measuring the CD of patterns. In embodiments, optical critical dimension (OCD) measurement equipment includes a tunable laser system in a light source unit and a method of measuring the CD of patterns.

This application claims the priority of Korean Patent Application No. 2003-99051, filed on Dec. 29, 2003, in the Korean Intellectual Property Office, the disclosure of which is incorporated herein in its entirety by reference.

2. Description of the Related Art

Examples of apparatuses that measure CD's of patterns formed on a photo mask or wafer are apparatuses using electronic beams (e.g. a scanning electron microscope (SEM)) and apparatuses using light of a specific wavelength range (e.g. optical critical dimension (OCD) measurement equipment).

A SEM can measure the CD of finer patterns than an optical microscope. Also, since the SEM can measure the CD of a substrate according to patterns or the CD of a pattern according to positions, it has an advantageous spatial resolution. However, as patterns are downscaled, the resolution of the SEM may be limited. However, differences may occur between the same CDs that are measured at different times, thus degrading short-period reproducibility. To improve the short-period reproducibility, the number of times the CDs of patterns are measured is increased and the average of measured CDs can be used. However, since accurate CDs cannot be measured, the uniformity of CDs cannot be precisely discriminated. Also, as the number of times the CDs are measured increases, the total time taken for measurement also increases, thus lowering productivity.

FIG. 1 is a construction diagram of OCD measurement equipment 100. Referring to FIG. 1, the OCD measurement equipment 100 includes a light source unit 110, a projector unit 120, a substrate support unit 130, and a spectrometer unit 140. The light source unit 110, which uses a white light source, emits light of a compound wavelength. The light is emitted from the light source unit 110 through the projector unit 120 and projected on a portion of a substrate loaded on the substrate support unit 130. The light is projected on the substrate and then reflected from the substrate. The spectrometer unit 140 detects the reflected light. Since the light is projected according to wavelengths by a beam splitter of the projector unit 120, the spectrometer unit 140 also detects the reflected light according to wavelengths and measures the reflection rate of light according to wavelengths. The measured reflection rate is the average of values obtained throughout the entire region on which light is projected, according to wavelengths. By using the measured reflection rate, the CDs of patterns formed on the substrate can be obtained.

FIGS. 2A and 3A each show the shape of patterns formed on a substrate. FIGS. 2B and 3B are graphs showing a variation of reflection rate in the visible light range, according to the shape of the patterns shown in FIGS. 2A and 3A. FIGS. 2B and 3B are analogized out of FIGS. 2A and 3B, using electromagnetic theory and regeneration algorithms. The graphs for pattern CDs are stored as data in the OCD measurement equipment 100. Accordingly, the OCD measurement equipment 100 can obtain the pattern CD using the stored graphs by measuring the reflection rate of a given substrate. The process is repeatedly by scanning other regions of the substrate in the x and/or y directions, so that the CD of the entire substrate is measured. By using the measured CD, the uniformity of patterns formed on a semiconductor substrate or a transparent substrate of a photo mask can be determined.

In the OCD measurement equipment 100, since the CD is measured using a difference of reflection rate according to wavelengths, the resolution and short-period reproducibility are superior to those of an SEM. However, the OCD measurement equipment 100 extracts only the reflection rate on a measured space according to wavelengths during a one-time measurement, but not the reflection rate of each of the patterns on the measured space. As described above, the measured CD is the average of CDs of patterns in a predetermined region of the substrate, on which light is projected. For this reason, the CD of the region according to patterns or the CD of a pattern according to positions cannot be precisely obtained.

Therefore, to obtain the CD of the entire substrate with a high spatial resolution, it is required to minimize the cross-section of light projected on a substrate and maximize the number of times the cross-section of light is scanned at a high density. However, to ensure an optical intensity that enables the spectrometer unit 140 to detect reflected light, it is difficult to reduce the cross-section of the projected light. As the number of times the cross-section of light is scanned increases, measurement time increases, lowering productivity.

### SUMMARY OF THE INVENTION

Embodiments of the present invention relate to optical critical dimension (OCD) measurement equipment, which has a high resolution, has a high spatial resolution, and enables ultrahigh-speed measurement of the CD of patterns. Embodiments of present invention relate to a method of measuring the CD of patterns using OCD measurement equipment.

According to aspects of embodiments of the present invention, OCD measurement equipment measures the critical dimension of patterns formed on a substrate. The OCD measurement equipment includes a light source optical system, a projector optical system, a substrate support unit, an image relay optical system, and an image detection optical system. The light source optical system emits light with wavelengths that change over time. The projector optical system projects the light emitted from the light source optical system on the substrate. The substrate support unit supports the substrate and the image relay optical system relays light reflected by the substrate. The image detection optical system detects the light relayed by the image relay optical system using a detector having a spatial resolution.

According to aspects of embodiments of the present invention, a method measures the critical dimension of patterns formed on a substrate. Light of a specific wavelength, emitted from a light source, is projected to the substrate. Light reflected by the substrate is detected, using a detector having a spatial resolution. According to embodiments, critical dimensions of patterns may be determined by repeating the performing light projecting and light detecting using different wavelengths of light.

### BRIEF DESCRIPTION OF THE DRAWINGS

FIG. 1 is a construction diagram of optical critical dimension (OCD) measurement equipment.

FIGS. 2A and 3A show the shape of patterns formed on a substrate.

FIGS. 2B and 3B are graphs showing a variation of reflection rate in the visible light range according to the shape of the patterns of FIGS. 2A and 3A.

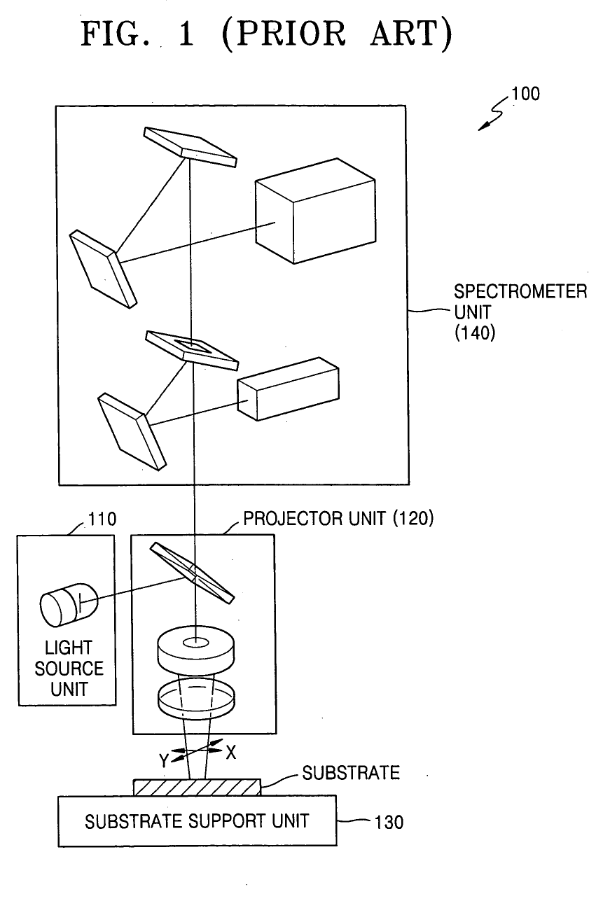

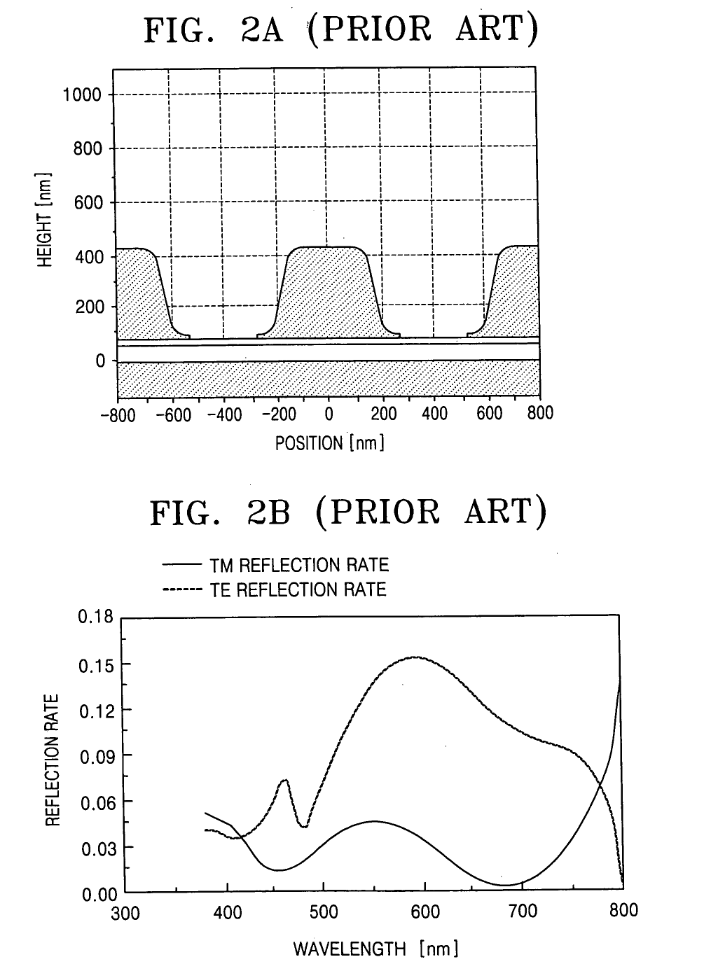

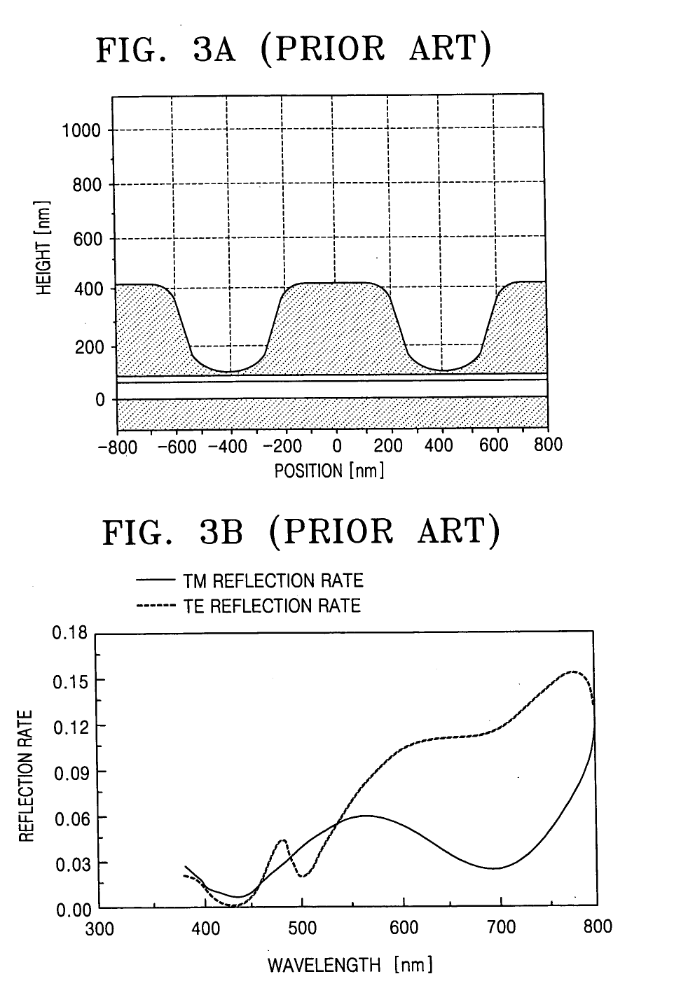

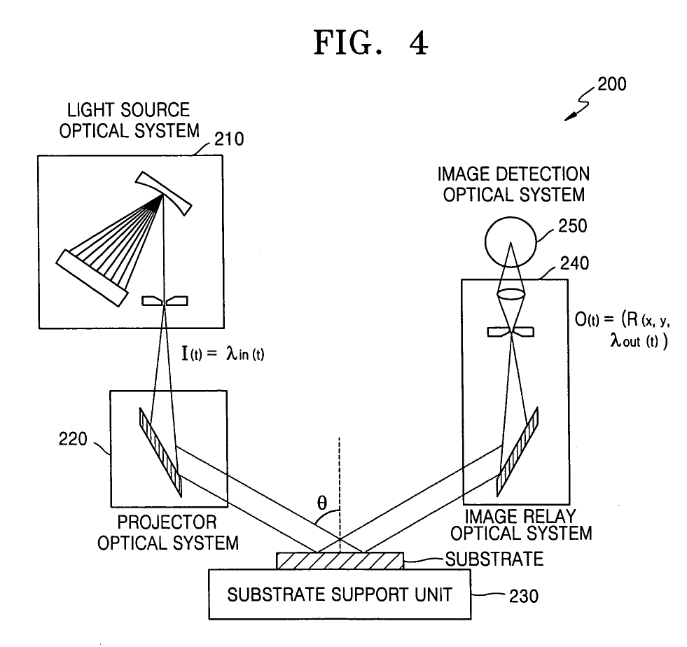

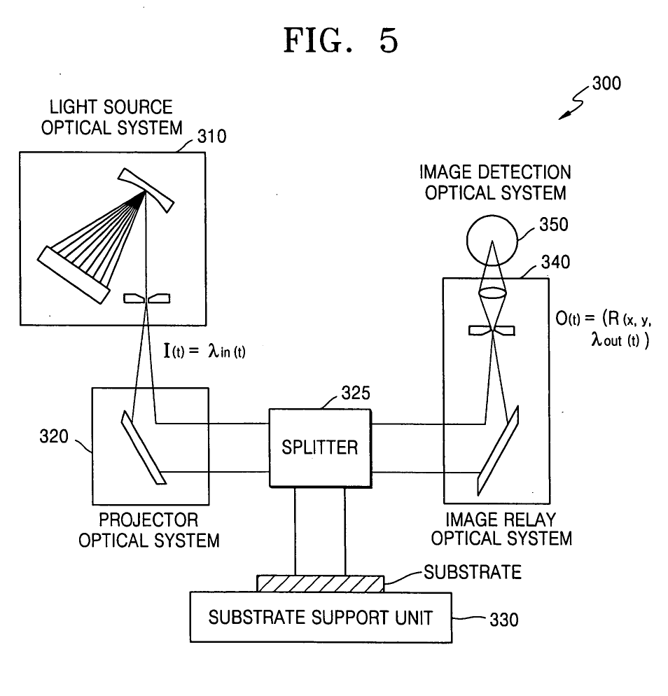

Example FIGS. 4 and 5 are construction diagrams of OCD measurement equipment.

### DETAILED DESCRIPTION OF THE INVENTION

The present invention will now be described more fully with reference to the accompanying drawings, in which example embodiments of the invention are shown. This invention may, however, be embodied in many different forms and should not be construed as being limited to the example embodiments set forth herein. Rather, these example embodiments are provided so that this disclosure is thorough and complete and fully conveys the concept of the invention to those skilled in the art. In the drawings, the thicknesses of layers may be exaggerated for clarity, and the same reference numerals are used to denote the same elements throughout the drawings.

Example FIG. 4 is a construction diagram of optical critical dimension (OCD) measurement equipment according to embodiments of the present invention. Referring to example FIG. 4, the OCD measurement equipment 200 includes a light source optical system 210, a projector optical system 220, a substrate support unit 230, an image relay optical system 240, and an image detection optical system 250.

The light source optical system 210 includes a system, which emits light of a specific wavelength. The spectral bandwidth of the system may be less than several tens of nanometers. For example, the system may be a tunable laser system. The wavelength of light emitted from the tunable laser system changes over time. As a result, the wavelength of light emitted from the light source optical system 210 changes over time (e.g. represented by I(t)=λᵢₙ(t)). The wavelength of light emitted from the system may have a specific spectral range.

The VSL-337ND-S nitrogen laser of Spectra-Physics Inc., which is an example of the tunable laser system, has a spectral range of 360 to 950 nm and a spectral bandwidth of 3 to 10 nm. The light source optical system 210 of embodiments of the present invention may use any kind of tunable laser system, which has similar performance as the VSL-337ND-S nitrogen laser, but it may have a different spectral range and bandwidth. The spectral range of the tunable laser system should be sufficiently wide to facilitate measurements of the OCD, but may vary according to the spectral range of the image detection optical system 250. For example, when the image detection optical system 250 can sense light of the visible light range, the spectrum range of the light source optical system 210 should include at least the visible light range.

The projector optical system 220 projects light λᵢₙ(t) emitted from the light source optical system 210 on a substrate loaded on the substrate support unit 230. The projector optical system 220 may include, for example, a condensing lens or various reflection mirrors. In embodiments, the projector optical system 220 projects the light λᵢₙ(t) at a predetermined angle θ to a vertical axis (as illustrated with a dotted line) of the substrate. The light may be projected on a portion or the entire substrate by the projector optical system 220. When the light is projected on the entire substrate, it may not be required to repeatedly project light in order to measure the CD of the entire surface of the substrate.

The substrate support unit 230 supports a substrate loaded on the OCD measurement equipment 200. In embodiments, the substrate may be a semiconductor substrate on which predetermined patterns are formed or a mask substrate on which a light blocking pattern or a pattern for phase shifting are formed.

The image relay optical system 240, for example, a body of an optical microscope, relays light reflected from a substrate to the image detection optical system 250. The image relay optical system 240 may include a reflection mirror, a pinhole, or a plurality of lenses.

The image deflection optical system 250 detects images of patterns formed on the substrate, using the light relayed by the image relay optical system 240. The image detection optical system 250 senses the wavelength of light reflected by the substrate and positions of the patterns of the substrate. That is, detected information also includes information on positions of the patterns (O(t)=R(x, y, λₒᵤₜ(t))). The image detection optical system 250 may include a detector having a high spatial resolution. A charge-coupled device (CCD) is an example of a detector. CCDs are used in digital imaging apparatuses (e.g. digital cameras and PC cameras) which convert light to electricity to detect the light.

Example FIG. 5 is a construction diagram of OCD measurement equipment, according to embodiments of the present invention. Referring to example FIG. 5, the OCD measurement equipment 300 includes a light source optical system 310, a projector optical system 320, a splitter 325, a substrate support unit 330, an image relay optical system 340, and an image detection optical system 350.

The OCD measurement equipment 300 may have a similar configuration as the OCD measurement equipment 200 of example FIG. 4, but equipment 300 also includes a splitter 325. The splitter 325 splits light into light that is incident from the projector optical system 320 on a substrate and light that is reflected from the substrate on the image relay optical system 340. The splitter 325 is required when the incident light is vertically incident on a substrate and has the same path as reflected light.

A method of measuring the CD of patterns formed on a substrate can use the OCD measurement equipment 200 or 300, according to the embodiments of the present invention. Initially, the light source optical system 210 or 310 emits light of a specific wavelength λ₁. The light source optical system 210 or 310 may include, for example, a tunable laser system. The projector optical system 220 or 320 projects the light, which is emitted from the light source optical system 210 or 310, on a substrate. According to the type of OCD measurement equipment 200 or 300, the light is incident at an angle (e.g. OCD measurement equipment 200) or vertically (e.g. OCD measurement equipment 300) on the substrate. When the light is incident at an angle on the substrate, the CD of finer patterns can be measured. On the other hand, when the light is vertically incident on the substrate, the CD of patterns can be measured more precisely.

The light reflected by the substrate is relayed by the image relay optical system 240 or 340 and detected by the image detection optical system 250 or 350. The image detection optical system 250 or 350 may be a CCD. When light of a given wavelength λ₁ is incident on a substrate, deflected light has spatial characteristics based on the spatial distribution of the deflected light.

The light source optical system 210 or 310 then emits light of a different wavelength λ₂ from the wavelength λ₁. The wavelength λ₂ of new light may be a predetermined value Δλ greater or less than the wavelength λ₁ of the previous light. For example, the wavelength variation Δλ can be equal to the spectral bandwidth of the tunable laser system included in the light source optical system 210 or 310. The reflected light of wavelength λ₂ is detected in a similar manner as light of wavelength λ₁. This process is repeated by altering the wavelength λ of light in the entire spectral range (e.g. in the visible light range). As a result, reflected light of the entire spectral range can be detected. Since the wavelength λ is altered by a high-frequency electric signal, it takes a relatively short period of time to project light in the entire spectral range. By synthesizing detection information on reflected light in the entire spectral range, the CDs of patterns formed on the substrate can be measured precisely.

The OCD measurement equipment of embodiments of the present invention can be manufactured by combining a tunable laser system and/or a CCD, with other optical units. Also, the OCD measurement equipment ensures high short-period reproducibility and precisely measures the CD of a substrate according to patterns or the CD of a pattern according to spatial distribution. Further, the CD of patterns formed on the entire substrate and the pattern CD uniformity can be measured at high speed.

While the present invention has been particularly shown and described with reference to example embodiments thereof, it will be understood by those of ordinary skill in the art that various changes in form and details may be made therein without departing from the spirit and scope of the present invention as defined by the following claims.

1. Optical critical dimension measurement equipment, which measures the critical dimension of patterns formed on a substrate, the equipment comprising:
a light source optical system, which emits light having wavelengths that change over time;
a projector optical system, which projects the light emitted from the light source optical system on the substrate;
a substrate support unit, which supports the substrate;
an image relay optical system, which relays light reflected by the substrate; and
an image detection optical system, which detects the light relayed by the image relay optical system using a detector which detects spatial distribution of the light.

2. The equipment of claim 1, wherein the light source optical system includes a tunable laser system.

3. The equipment of claim 2, wherein the spectral range of light emitted from the tunable laser system includes a visible light wavelength range.

4. The equipment of claim 1, wherein the detector include a charge-coupled device.

5. The equipment of claim 1, wherein the projector optical system projects light at an angle on the substrate.

6. The equipment of claim 1, wherein the projector optical system projects light vertically on the substrate.

7. The equipment of claim 6, further comprising a splitter which splits light into incident light, which is incident from the projector optical system on the substrate, and reflected light, which is reflected from the substrate on the image relay optical system.

8. A method of measuring the critical dimension of patterns formed on a substrate, the method comprising:
projecting light of a specific wavelength on the substrate;
detecting spatial distribution of light of the specific wavelength reflected by the substrate;
determining the critical dimensions of the patterns by repeating the projecting and the detecting by varying the wavelength of the light of the specific wavelength.

9. The method of claim 8, wherein the light of the specific wavelength is in a visible light wavelength range.

10. The method of claim 8, wherein the light source includes a tunable laser system.

11. The method of claim 8, wherein the detector includes a charge-coupled device.

12. The method of claim 8, the projecting light is projecting light at an angle on the substrate.

13. The method of claim 8, wherein the projecting light is projecting light vertically on the substrate.

14. An apparatus comprising:
a light source which distributes light onto a surface, wherein the wavelength of the light is varied over time; and
a light detector which receives the light after it is reflected off of the surface and detects the spatial distribution of the light at different wavelengths.

15. The apparatus of claim 14, wherein the surface is a semiconductor substrate.

16. The apparatus of claim 15, wherein the apparatus determines dimensions of patterns formed on the semiconductor substrate.

17. The apparatus of claim 16, wherein the apparatus determines dimensions of patterns formed on the semiconductor substrate by analyzing the spatial distribution of light detected by the light detector in relation to the wavelength of the light received by the light detector.

18. The apparatus of claim 14, wherein the light detector comprises a charge coupled device.

19. The apparatus of claim 14, wherein the light is reflected off of the surface at an angle.

20. The apparatus of claim 19, wherein the angle is a right angle.
